(19) United States
(12) Patent Application Publication
(10) Pub. No.: US 2017/0140099 A1
(43) Pub. Date: May 18, 2017

(54) FACILITATING THE SHARING OF HEALTH INFORMATION

(71) Applicant: Edward Worthington, II, Maple City, MI (US)

(72) Inventor: Edward Worthington, II, Maple City, MI (US)

(21) Appl. No.: 14/943,682

(22) Filed: Nov. 17, 2015

(51) Int. Cl. G06F 19/00

(52) U.S. Cl. CPC G06F 19/322

(57) ABSTRACT

A system for facilitating the sharing of health information is provided herein. The system may be implemented at a server-side, intermediary location, or client-side (or combination of some or all). The system employs records of patient access to health to create a database of known locations and sessions in which the patient is assigned to a various network of health information exchanges (HIE).

### BACKGROUND

Traditionally, health services have been provided by a single care giver to a recipient, such as a patient. Thus, a patient would go to a clinic or hospital in which the patient is a member of, and obtain health-related services.

More recently, health care has been provided by networks. The networks allow a patient to go to various locations, such as pharmacies, clinics, hospitals and the like, and receive various health needs.

The networks may be geographically isolated, for example, in a city or county. Some health care networks may be national, or serve a larger scope. In either case, patients are likely to go to a variety of labs, clinics, and hospitals to satisfy a variety of health care needs. Further, patients are likely to attend a variety of locations and regions. For example, a patient may visit health care providers in multiple cities, counties, or states.

The existing technique involves a patient having an identification (ID) for each isolated health care provider. If the multiple locations are in the same network, the networks may allow or facilitate the sharing of information with each other. However, if the multiple locations are not in the same network, the personnel or the systems at the multiple locations may not be able to be cognizant of the same patient utilizing services at each of the multiple locations.

By not being aware of services received by a patient, a health care provider is limited in the quality of service in which the health care provider may offer. Further, because of the inefficiency associated with handshaking between each of the networks associated with each individual health care provider (or network), the process of obtaining a complete image of the patient's health and history data may be ultimately frustrated or made difficult.

Some organizations have tried to provide a universal identification. For example, the state of Michigan is working towards providing a unique ID for each subscriber. However, the same problem becomes apparent. A patient may leave the state of Michigan and the ID would have to be propagated to the other states. Further, different health providers may open and close. Thus, even if an ID is created, the ID would still need to be propagated to various providers and networks. In some situations, even if the identification from a source were to be propagated, the recipient systems would have to reconcile it with their current identification scheme for a patient. Thus health care providers would be burdened with a huge overhaul process required for adoption of a global identifier.

### SUMMARY

A system for facilitating a sharing of health information is provided herein. The system includes a request receiver configured to receive a request for the health information associated with a patient; a patient information receiver configured to receive information about the patient; a patient correlator configured to correlated the received information with shared information from a community data store, wherein the patient correlator is configured to match extracted demographic information from the received information, and employ the extracted demographic information to perform the correlation.

Another system for facilitating a sharing of health information is provided herein. The system includes a record receiver configured to receive a patient information record about a patient; a record organizer configured to organize the received patient information record with matching previously received patient information; and a connection updater configured to transmit the organized received patient information record to a second system for facilitating the sharing of health information.

Another system for facilitating a sharing of health information is provided herein. The system includes a patient information configured to receive information about a patient's visit to a health information exchange (HIE) network; a demographic transmitter configured to extract demographic information about the patient, and transmit the extracted demographic information to an external server via a network connection; and an information accepter configured to accept additional information via the network connection.

### DESCRIPTION OF THE DRAWINGS

The detailed description refers to the following drawings, in which like numerals refer to like items, and in which:

FIG. 1 is a block diagram illustrating an example computer.

FIG. 2 illustrates an example of a system for facilitating the sharing of health information (server-side).

FIG. 3 illustrates an example of another system for facilitating the sharing of health information (intermediary).

FIG. 4 illustrates an example of a system for facilitating the sharing of health information (client-side).

FIG. 5 illustrates an example implementation of system of FIG. 4 with a patient.

FIG. 6 illustrates an example of the ADT information that may be employed with various aspects disclosed herein.

FIG. 7 illustrates an example method for facilitating the sharing of health information.

FIG. 8 further illustrates the method of FIG. 7 being implemented with the systems described in FIGS. 2, 3, and 4.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

The providing of health care is greatly improved when a provider is cognizant of a patient's complete history. However, because many different locations and places provide health care, the present location providing health care services may be ultimately frustrated by the inefficiency of having to handshake and share information between the multiple providers and networks.

As explained in the Background section, the current method for sharing information is realized by an individual health care provider contacting each identified other health care providers associated with the patient. After contact, the other health care providers may require some sort of authentication or permission scheme to share records.

In some cases, the personnel or systems at the present location may contact other locations, and retrieve health care information from the other locations. For example, a clinic in a first network may contact a clinic in the second network. The clinic in the second network may require the clinic in the first network to provide authentication information, as well as additional identification for security and privacy purposes. Thus, by introducing a hurdle in the process of sharing information, health care is inefficiently provided. Further, automated systems to share information may be blocked due to one party not being in a membership with another party.

Disclosed herein are methods and systems for facilitating the sharing of health information. The methods and systems may be implemented at various locations and contexts associated with the providing of health care. In one example, the aspects disclosed herein are implemented on a client-side. In another example, the aspects disclosed herein are implemented on a server-side. In another example, the aspects disclosed herein are implemented in both the client-side or the server-side, or an intermediary location between both locations.

The aspects disclosed herein facilitate efficient information exchange between multiple existing HIEs. This allows for efficient scaling as closed-data systems are interfaced together and required to share information.

Further, according to the aspects disclosed herein, the various systems may be replicable on a larger scale. Thus, each of the systems may be duplicated and scaled to support a larger user-base.

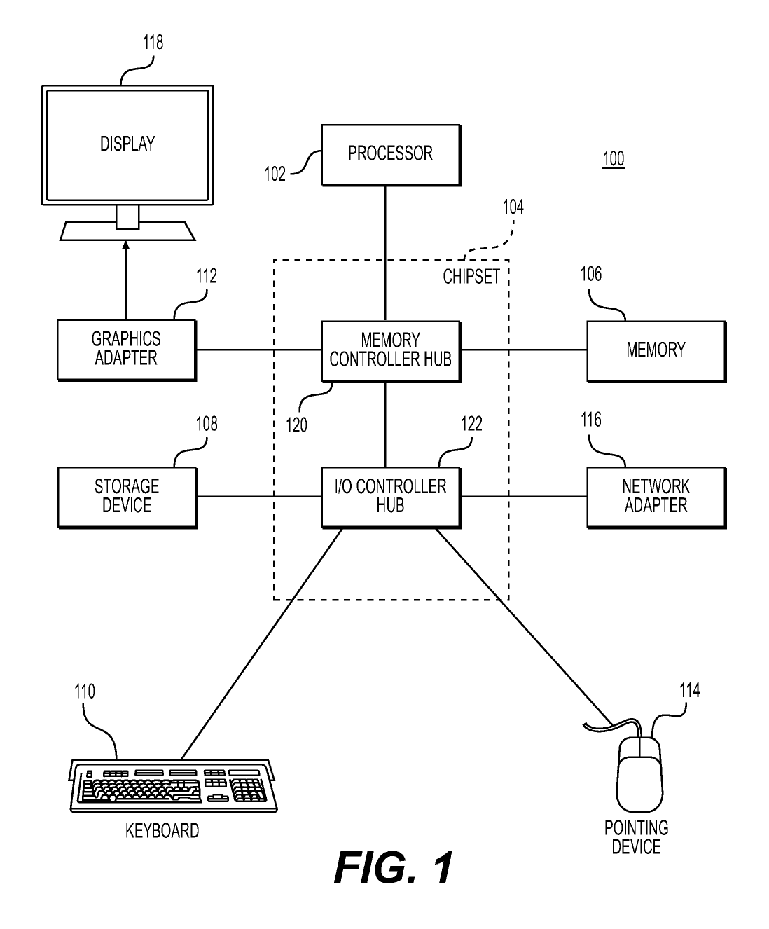

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server. The various computer 100 devices that constitute the server may communicate with each other over a network.

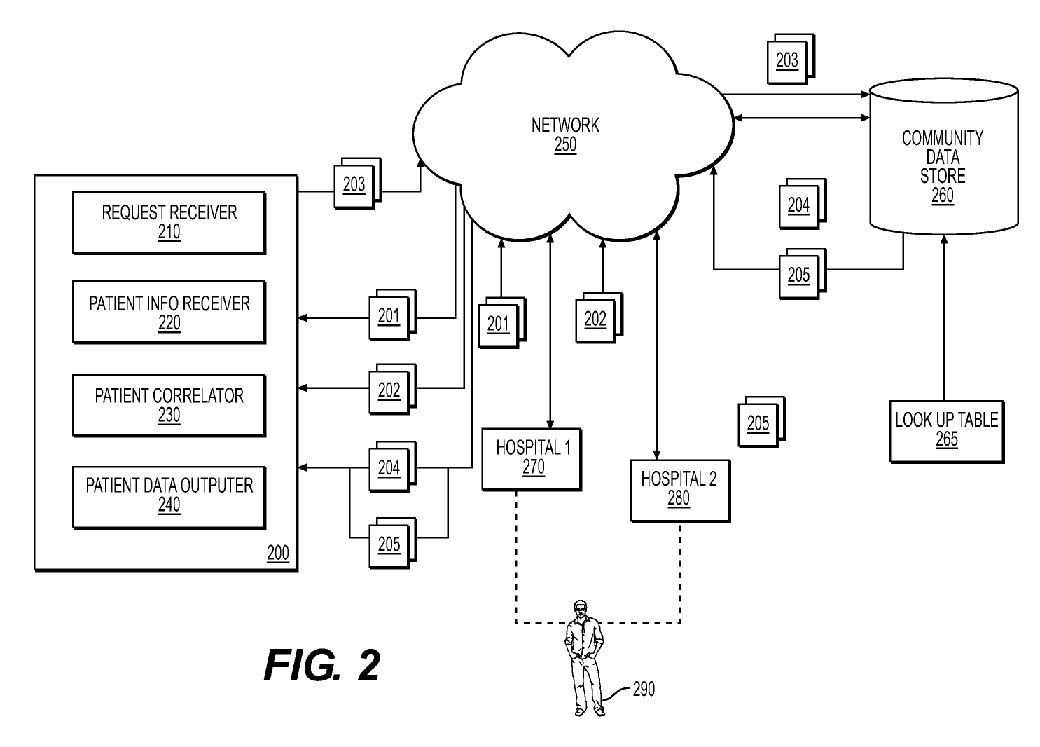

FIG. 2 illustrates an example of a system 200 for facilitating the sharing of health information. The system 200 may be implemented on a computer, such as the computer 100 shown above. Also shown in FIG. 2 are various storage devices and computer elements. The various storage devices and computer elements may be performed by elements known in the art, such as those enumerated above.

The system 200 includes a request receiver 210, a patient information receiver 220, a patient correlator 230, and a patient data outputter 240. The system 200 is communicatively coupled to a community data store 260 via a network 250. The network 250 may be any networking medium known in the art. Thus, the system 200 is configured to receive data to and from the network 250, and from the community data store 260. In certain cases, the system 200 may be embedded in the community data store 260 and integrally provided.

Network 250 is any network capable of allowing information, for example data packets and/or files, to communicate from one device to another. For example, network 250 may be a local area network (LAN), a wide area network (WAN), or a combination of the above, or other types of networks. The network 250 allows various health information exchanges (HIE) to communicate with each other. As shown for exemplary purposes in FIG. 2, hospital 1 270 and hospital 2 280 are provided. These are examples of HIEs, which may be numerous in types and services. The HIE allows for the mobilization of healthcare information electronically across organizations within a region, community or hospital system. In practice the term HIE may also refer to the organization that facilitates the exchange. For example, a HIE may be one of the following: labs, hospitals, clinics, pharmacies, public health organizations, paying organizations, and the like.

The request receiver 210 receives a request 201 from the network 250. As explained below, the request 201 may be generated from a HIE, such as hospital 1 270. The request 201 is an indication that a patient 290 has entered hospital 1 270 and is being provided with health services.

Once the request 201 is received, the system 200 may receive information 202 about the patient 290 via the patient information receiver 220. The patient information receiver 220 may receive patient information 202 via a health-care messaging protocol known as admit-discharge-transmit (ADT).

The ADT messages carry patient demographic information for HL7 communications but also provide important information about trigger events (such as patient admit, discharge, transfer, registration, etc.). Thus, every time a patient 290 enters into a HIE (for example, hospital 1 270 or hospital 2 280), an ADT message is generated (as denoted in FIG. 2 by information 202).

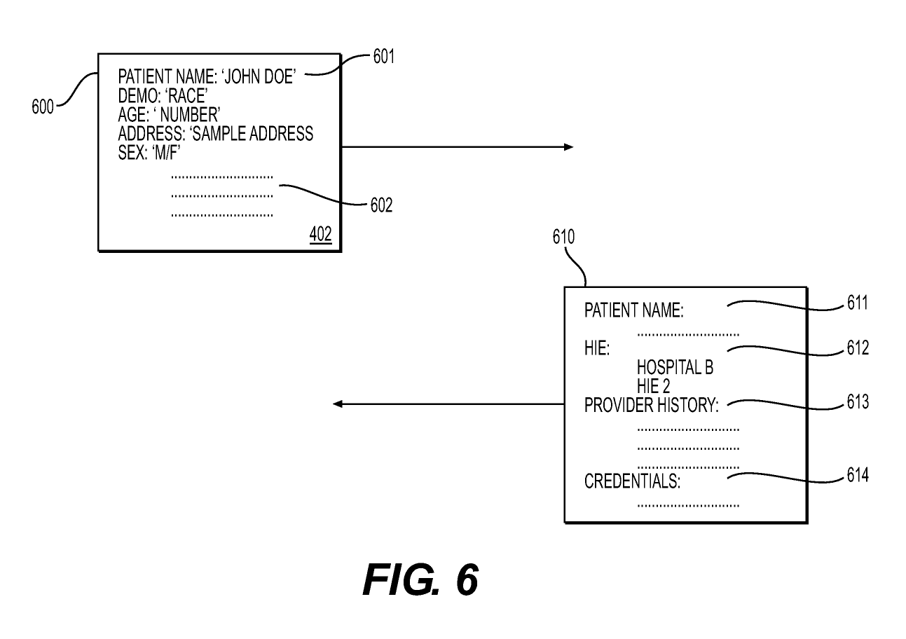

Thus, as explained above, the system 200 generates ADT messages (via information 202) and extracts the information to obtain key elements of the patient 290. An example of the some of the information/demographics that may be propagated is shown in FIG. 6 and will be described in greater detail below.

The information to be propagated to a community data store 260, for example may be the information extracted from information 202 (shared information 203). The community data store 260 stores information of all the data associated with the participating HIE (for example, hospital 1 270 and hospital 2 280). The community data store 260 may refer to a lookup table 265, and retrieve correlated information 204 that matches the shared information 203

Correlated information 204 is received by the patient correlator 230. The patient correlator 230 may correlate the received correlated information 204, and verify whether the correlated information 204 corresponds with the shared information 203.

In an alternate implementation of system 200, the community data store 260 may be configured to communicate additional information 205. For example, in one instance, the additional information 205 may be a request for additional information. For example, hospital 2 280 may require a password or permission key to retrieve information. Thus, the party receiving the additional information 205 may be prompted with a secondary authentication process.

In another example, the additional information 205 may be a certificate or security key employable by a receiving party to access a specific information data store associated with another HIE. In the cases described above, the various additional information 205 may be provided with a specific time-out parameter, and thus, the information may be only accessible for a predetermined amount of time.

The patient data outputter 240 may communicate either or both the correlated information 204 and the additional information 205 to a receiving party. The receiving party, for example, may be the party making the request 201 to receive the patient history associated with patient information 202. For example, if hospital 1 270 submits a request 201 with patient information 202, hospital 1 270 may receive both correlated information 204 and/or additional information 205.

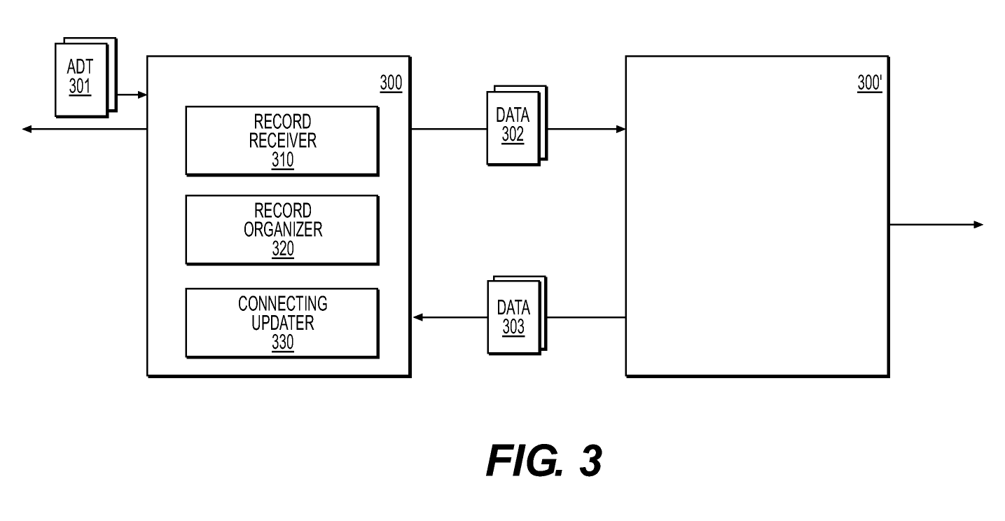

FIG. 3 illustrates an example of a system 300 for synchronizing health information according to an exemplary embodiment disclosed herein. The system 300 may be implemented with system 200, system 400, or both. The system 300 may be installed on a processor, such as computer 100 described above.

The system 300 includes a record receiver 310, a record organizer 320, and a connection updater 330. The system 300 may be implemented along with a similar system 300, shown as system 300′.

The record receiver 310 receives ADT information 301 from an external source (for example, a hospital or a HIE). The system 300 may be configured to store information about a specific patient (or group of patients) associated with affiliated ADT information 301. Thus, whenever information is received from about a patient (for example, information contained by a specific or affiliated ADT information 301), the system 300 may store the information.

The ADT information 301 is then processed by the record organizer 320, and communicated to other systems, such as system 300′. Both system 300 and 300′ each include a connection updater 330, which updates information about patients that match based on received ADT information 301. Data 302, which is similar to extracted information 203 described above, may be propagated to other systems, such as system 300′.

Thus, as shown in FIG. 3, the system 300 may receive data 303 indicating that system 300′ has received ADT information associated with a patient that the ADT 301 is also associated with. Received data 303 may be an updated file/list of all the HIEs in which the patient associated with ADT information 301 is associated with.

Accordingly, each system 300 may dynamically maintain a database associated with affiliated patients. Thus, if a patient 290 generates ADT information 301, the system 300 may periodically ensure that information from other HIEs, such as one that is affiliated with system 300′ is cross-referenced and stored in system 300. In this way, each health network may be associated with a system 300, and employing the aspects disclosed in FIG. 3, the various system 300s may handshake with each other and share information about each patient based on the ADT information received. Thus, system 300 allows a dynamic updating of relationships and cross-linked information associated with a specific patient. For example, a patient may go to various HIEs. System 300, which may be run as a background process, may update the relationship.

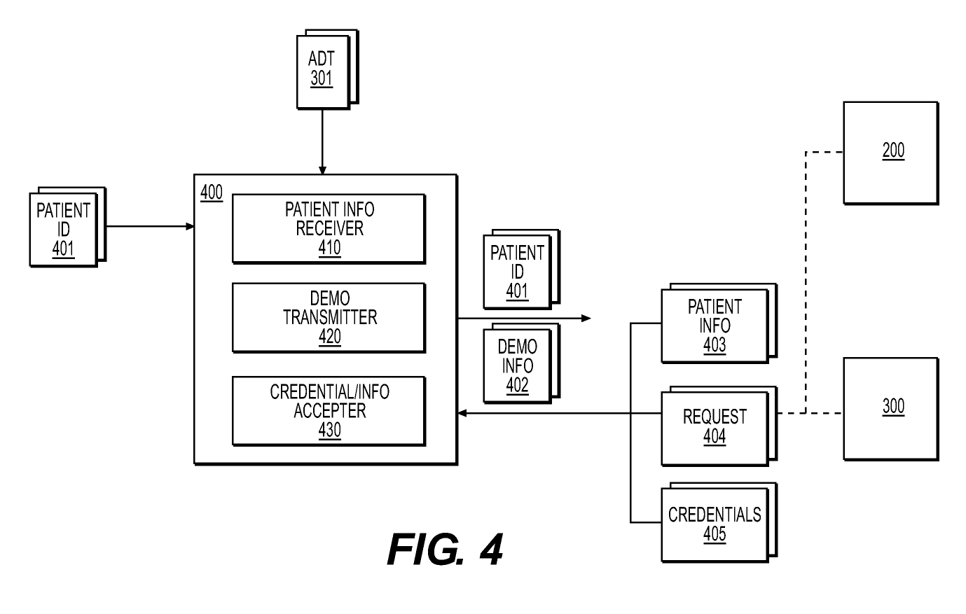

FIG. 4 illustrates another example of a system 400 for facilitating the sharing of health information according to an exemplary embodiment. The system 400 is a client-side implementation of the system 200. The system 400 may communicate with either the system 200 shown in FIG. 2, or system 300 shown in FIG. 3, and receive the information described with regards to FIG. 4.

The system 400 includes a patient information receiver 410, a demographic transmitter 420, and a credential/information accepter 430. The system 400 may receive patient identification 401 associated with a patient visit. A user engaging with a computer 100 associated with system 400 may enter the patient information 401 through a keyboard or other input device. Concurrently, the patients visit also is associated with ADT information 301 (which is generated at the location in which the system 400 is implemented). The ADT information 301 includes information about the patient's visit, and other information about the patient (such as the information shown in FIG. 6).

The demographics/information associated with the patient is extracted and transmitted to either system 200 or (if you 300 (or both). The demographic information 402 is transmitted, and employing the aspects described above, system 200 or 300 returns additional information 204/205 such as those shown in FIG. 4.

The additional information may be additional patient information 403 (for example, records from other HIEs), an additional request for information 404, or credentials for accessing information 405. Thus, the user associated with system 400 may receive the additional information 204/205 and either review the additional health records, or obtain additional health records from other HIEs.

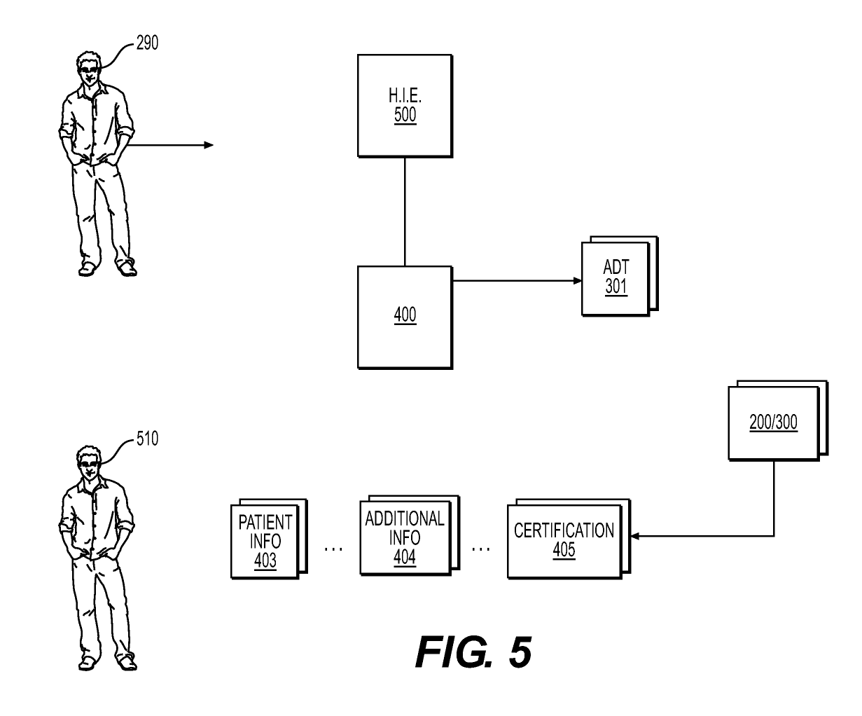

FIG. 5 illustrates an example implementation of system 400 with a patient 290. In the example shown, patient 290 visits a location that is associated with HIE 500. HIE 500 implements system 400, and thus, employs the aspects disclosed herein to produce an ADT information 301 associated with the care/services provided to patient 290.

The user 510 may generate a request 201 to either system 200 or 300, and in accordance with the aspects disclosed herein, receive additional information 204/205 (such as those shown in FIG. 5).

FIG. 6 illustrates an example of the ADT information 301 that may be employed with various aspects disclosed herein. The information shown is exemplary, and thus, other information or categories of information may also be used. The information shown in sample ADT 600 includes demographic information and other information such as the name, the race, the age, the address, the sex, and the like of the patient 290. Additionally, as shown in the sample ADT 600, the type of care 602 may also be included.

Thus, employing the aspects disclosed herein, the ADT information 600 may be submitted via or through systems 200, 300, and 400, and processed to produce sample additional information 610. As shown in the sample additional information 610, the following information is retrieved, the patient name 611, the various member HIEs 612, the patient history 613, and other credentials 614 for accessing additional information. The additional information 610 is exemplary, and thus, various combinations and permutations of the information discussed herein may be employed to implement the additional information 204/205 disclosed herein.

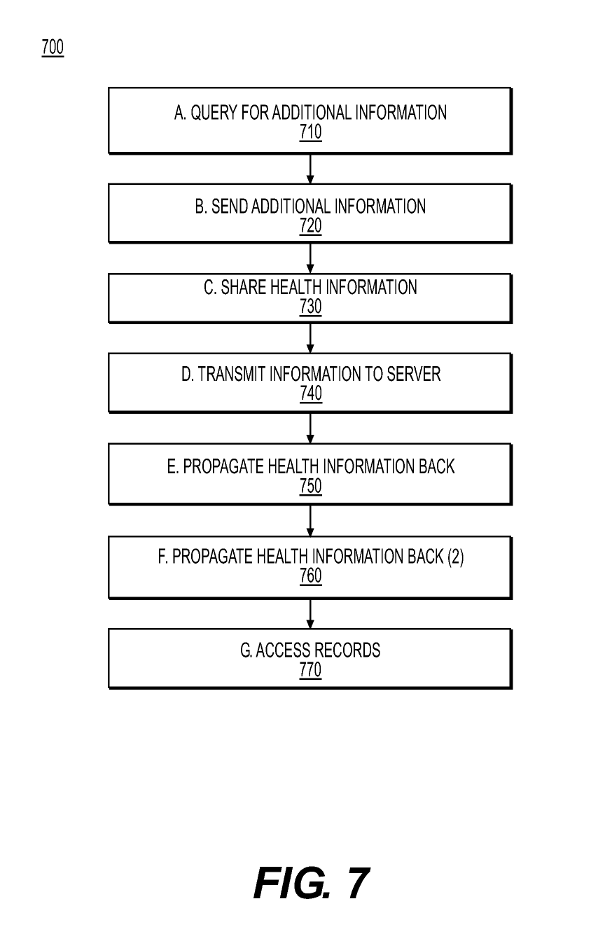

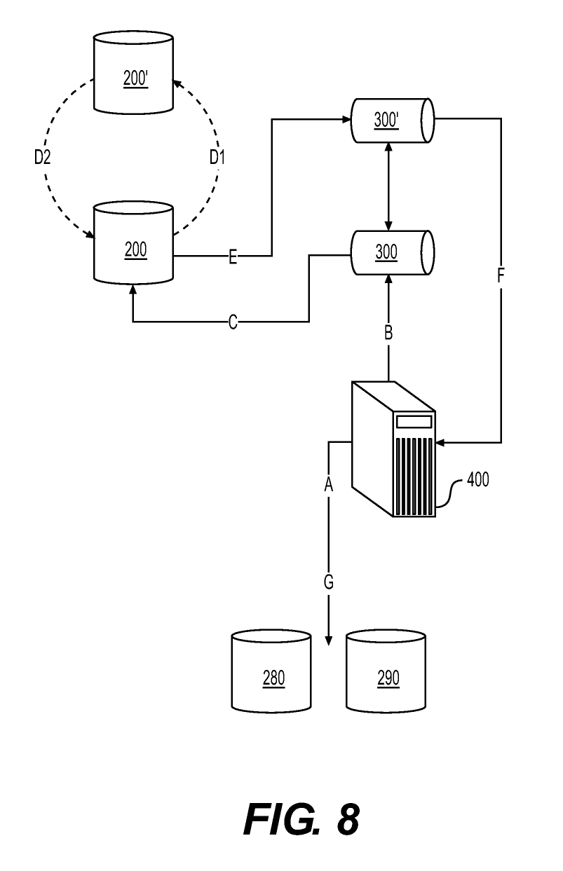

FIG. 7 illustrates an example method 700 for facilitating the sharing of health care information. FIG. 8 further illustrates the method 700 being implemented with the systems described above.

In operation 710 (as shown as A in FIG. 8), an operator at system 400 queries for additional information. In operation 720 (as shown as B in FIG. 8), the system 400 may send additional information required to determine if the user associated with the query in operation 710 is associated with additional information. As shown in FIG. 8, the information is passed to a system 300, which is constantly syncing with a system 300′. In another implementation of method 700, the system 400 may directly communicate with the system 200.

In operation 730 (as shown as C in FIG. 8), the information received in operation 720 (the query and the additional information) is further propagated to a system 200. The system 200 may be implemented along with other system 200s, such as system 200′.

In operation 740 (as shown as D in FIG. 8) a list of communities in which the patient associated with the query is received via system 200 (for example, from system 200′). The system 200 propagates the information about the patient (for example, an identification, demographic information, or as described above), and in turn, receives additional health information associated with that patient. In operations 750 and 760 (as shown as E and F), are propagated back to the original system 400 that made the query initially. The system 400 may then query additional communities, such as HIE 270 and 280, to obtain information about the patient (as shown as G in FIG. 8).

Thus, employing the aspects disclosed herein, systems for facilitating the sharing of health information may be implemented at various locations at contexts, such as at a server-side (system 200), an intermediary (system 300), and a client-side (system 400). By employing the aspects disclosed herein, a system administrator or health care facility may reduce many of the inefficiencies in the contemporary setup involving the sharing of health information. Because ADT information is used to create and populate databases of shared information, health networks may quickly access known databases of patient health records.

One such advantage of this disclosure, is that population level information may run concurrently with the individual patient matching disclosed herein. Thus, instead searching and matching one patient according the aspects disclosed herein, a population or group of patients may be matched (e.g. patients from the ages of X to Y with heart failure). This is advantageous because 1) it facilitates communication between parties in a more efficient manner; 2) allows third parties to license and leverage the platform to more cheaply develop and deploy interconnected health care applications; and 3) it allows the development of applications/systems that more widely and efficiently monitors health at a population level.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for facilitating a sharing of health information, comprising:
a data store comprising a computer readable medium storing a program of instructions for the facilitating of the sharing;
a processor that executes the program of instructions;
a request receiver configured to receive a request for the health information associated with a patient;
a patient information receiver configured to receive information about the patient;
a patient correlator configured to correlated the received information with shared information from a community data store,
wherein the patient correlator is configured to match extracted demographic information from the received information, and employ the extracted demographic information to perform the correlation.

2. The system according to claim 1, wherein the received information is of an admit-discharge-transfer (ADT) message.

3. The system according to claim 1, further comprising a patient data outputter configured to output additional information about the patient based on the shared information.

4. The system according to claim 3, wherein the additional information is defined as information pertaining to visits to health information exchanges (HIE) associated with the patient.

5. The system according to claim 3, wherein the additional information is defined as information associated with a credential or authorization to access a health information exchange (HIE) associated with the patient.

6. A system for facilitating a sharing of health information, comprising:
a data store comprising a computer readable medium storing a program of instructions for the facilitating of the sharing;
a processor that executes the program of instructions;
a record receiver configured to receive a patient information record about a patient;
a record organizer configured to organize the received patient information record with matching previously received patient information; and
a connection updater configured to transmit the organized received patient information record to a second system for facilitating the sharing of health information.

7. The system according to claim 6, wherein the received patient information is of an admit-discharge-transfer (ADT) message.

8. The system according to claim 6, wherein the system is associated with a first health information exchange (HIE) associate with a first global identifier, and the second system is associated with a second HIE with a second global identifier, the first and second global identifier being associated with the patient.

9. A system for facilitating a sharing of health information, comprising:
a data store comprising a computer readable medium storing a program of instructions for the facilitating of the sharing;
a processor that executes the program of instructions;
a patient information configured to receive information about a patient's visit to a health information exchange (HIE) network;
a demographic transmitter configured to extract demographic information about the patient, and transmit the extracted demographic information to an external server via a network connection; and
an information accepter configured to accept additional information via the network connection.

10. The system according to claim 9, wherein the received information about the patient is of an admit-discharge-transfer (ADT) message.

11. The system according to claim 10, wherein the additional information is defined as additional information about the patient from a second HIE.

12. The system according to claim 10, wherein the additional information is defined as a request for additional authentication to access a second HIE.

13. The system according to claim 10, wherein the additional information is defined as credentials to access a second HIE.
